(19) United States
(12) Patent Application Publication
(10) Pub. No.: US 2018/0157799 A1
(43) Pub. Date: Jun. 7, 2018

(54) METHODS AND SYSTEM FOR MANAGING CARE PLAN OF A PATIENT

(71) Applicant: Marshfield Clinic Information Services (MCIS), Marshfield, WI (US)

(72) Inventors: Ryan Ketterer, Arpin, WI (US); Kristi McGregor, Marshfield, WI (US); Chris Kolstad, Marshfield, WI (US); Brad Bekkum, Rice Lake, WI (US); Kate Konitzer, Arpin, WI (US); Lori Polzin, Stevens Point, WI (US)

(21) Appl. No.: 15/367,598

(22) Filed: Dec. 2, 2016

(51) Int. Cl. G06F 19/00

(52) U.S. Cl. CPC G06F 19/345; G06F 19/322

(57) ABSTRACT

The disclosure is directed to a care plan management system that manages a care plan associated with an individual, e.g., a patient. The care plan is an electronic record of a treatment provided to the patient for various problem conditions. The care plan depicts a detailed medical history of the patient for various treatments received across multiple healthcare providers. The care plan can include multiple care plan items in which each care plan item corresponds to a problem condition and includes a treatment plan, e.g., a goal of the treatment, instructions to the patient and/or healthcare providers, an order list, medications, and/or notes. By providing access to an entire medical history of the patient, the care plan management system facilitates an healthcare provider in diagnosing and therefore, formulating a comprehensive treatment plan for the patient.

### BACKGROUND

The documented medical history of an individual often plays a significant role in providing quality healthcare to the individual. A healthcare provider may analyze an individual's history and seek to provide appropriate and accurate treatment accordingly. It can often be difficult for a healthcare provider, e.g., a healthcare facility, and/or a healthcare professional such as a doctor, a surgeon, a lab technician, a nurse, to know how a specific problem condition is being treated. Understanding how the problem condition is being treated may often require analyzing several clinical documents. Further, the clinical documents may be from different healthcare providers, which results in the need to “merge” information to get an overview of how the problem condition is being managed. Additionally, methods of documenting medical history can differ, e.g., sections in the documents and location of information differ between healthcare providers, causing inefficiencies when trying to identify the most relevant information. That is, the information that may be needed to formulate a complete care plan is not easily discoverable. Even if the information is discoverable, the information is not typically organized, prioritized, and/or aggregated.

Because it is difficult to obtain all the pertinent information regarding how a problem condition is being treated, conflicting items can occur within the care plan. For example, a blood pressure goal may be set by a first healthcare provider, e.g., a primary care doctor, and then a second healthcare provider, e.g., a specialist doctor, may adjust that goal. When the patient is seen by the primary care doctor, or seen by another specialist doctor, the adjusted goal can be missed, which can result in the patient's problem condition not being managed as effectively as it could be. This can cause confusion and even harm to the patient.

Because the care plan is often not coordinated horizontally across specialties, and because it is not consistently updated to ensure that it is the most accurate and current, it can be difficult for a patient to understand the care team's instructions regarding the management of a specific problem condition. Patients receive conflicting information from different specialties, leading to confusion, potential callbacks to the care team, and potential rework for the care team to reconcile conflicts.

Current healthcare systems are unable to supply to the patient a comprehensive view of the healthcare management specified by their various healthcare providers, of all their health problems. Because this information is not available to be shared with the patient, organizations are unable to engage the patient as a contributing member to their own health record.

Further, many high cost diseases have “best practice” guidelines for treatment. It can be difficult for care teams to recall these best practices at the point of care when establishing a care plan for the patient.

Furthermore, healthcare providers may generally only take a problem-specific view of how a patient is being managed. This problem-specific view is generally obtained by reviewing the patient's most recent clinical documents. When reviewing the most recent clinical documents, the healthcare provider assumes the care plan has been reconciled across multiple healthcare providers. In order to obtain a comprehensive view of the patient's treatment, healthcare providers are required to look at multiple documents/sources to find the relevant data and then manually aggregate the information.

Patients have to manually aggregate goals, instructions, and orders to get the most comprehensive view of how all their problems are being addressed. It is often necessary for the patient to consult with the care team to reconcile inconsistent information spanning multiple visits, which could also span across multiple specialties.

### BRIEF DESCRIPTION OF THE DRAWINGS

FIG. 1 is a block diagram of an environment in which the disclosed embodiments may be implemented.

FIG. 2 is a screenshot of a care plan GUI, consistent with various embodiments.

FIG. 3 is a screenshot of a care plan GUI illustrating generating recommendations for treatment and adding the recommendations to a care plan, consistent with various embodiments.

FIG. 4 is a block diagram of the server of FIG. 1, consistent with various embodiments.

FIG. 5 is a flow diagram of a process for generating a care plan item for treating a specified problem condition associated with the patient, consistent with various embodiments.

FIG. 6 is a flow diagram of a process for updating a care plan item of a care plan, consistent with various embodiments.

FIG. 7 is a flow diagram of a process for populating a care plan management system of FIG. 1 with recommended treatment plans from a third-party source, consistent with various embodiments.

FIG. 8 is a flow diagram of a process for determining a conflict in the care plan, consistent with various embodiments.

FIG. 9 is a flow diagram of a process for generating a notification of an occurrence of an event in the care plan, consistent with various embodiments.

FIG. 10 is a screenshot of a care plan GUI, consistent with various embodiments.

FIG. 11 is another screenshot of a care plan GUI, consistent with various embodiments.

FIG. 12 is another screenshot of a care plan GUI, consistent with various embodiments.

FIG. 13 is another screenshot of a care plan GUI, consistent with various embodiments.

FIG. 14 is a screenshot of an admin tool of the care plan management system, consistent with various embodiments.

FIG. 15 is another screenshot of the admin tool, consistent with various embodiments.

FIG. 16 is another screenshot of the admin tool, consistent with various embodiments.

FIGS. 17A-17C illustrate screenshots of an evidence-based recommendation template received from third-party sources, consistent with various embodiments.

FIG. 18 is a block diagram of a processing system that can implement operations, consistent with various embodiments.

### DETAILED DESCRIPTION

Embodiments are directed to a care plan management system that manages a care plan associated with an individual, e.g., a patient. The care plan is an electronic record of a treatment provided to the patient for various problem conditions associated with the patient. The care plan depicts a detailed medical history of the patient for various treatments received across multiple healthcare providers. A healthcare provider can be a facility, such as a clinic, a hospital, urgent care, a laboratory; and/or a healthcare professional, such as a doctor, a surgeon, a lab technician, or a nurse. The care plan of a patient can include multiple care plan items in which each care plan item corresponds to a specified problem condition associated with the patient and includes a treatment plan for treating the problem condition. For example, a care plan item includes a problem condition, a goal of the treatment, instructions to the patient and/or healthcare providers, an order list, medications, and/or notes. The care plan of a patient is accessible to any of the healthcare providers that are authorized by the care plan management system. By providing access to an entire medical history of the patient, regardless of which healthcare provider treated the problem conditions, the care plan management system facilitates a healthcare provider in diagnosing the patient comprehensively, and therefore, in formulating a comprehensive treatment plan. In addition, the care plan management system facilitates the patient to get a complete overview of his/her care plan from a single source. For example, the care plan management system can implement a website and/or a mobile app that provides a care plan graphical user interface (GUI) to access the care plan associated with the patient. Both the healthcare providers and the patient can access the care plan GUIs. In some embodiments, the care plan management system provides different versions of the care plan GUIs for the patient and the healthcare providers.

When a patient visits a healthcare provider for obtaining treatment for a specified condition, the healthcare provider can diagnose the patient and input the diagnosis information to the care plan management system. The care plan management system can store the diagnosis information as a care plan item. For example, the healthcare provider can retrieve the care plan associated with the patient from the care plan management system, or create one if there is no care plan associated with the patient, add the specified problem condition of the patient and a treatment plan, e.g., a goal of the treatment, instructions to the patient and/or healthcare providers, an order list, medications, and notes, based on the diagnosis information, and save it as a care plan item in the care plan management system. The saved care plan is accessible by various healthcare providers and/or the patient.

Continuing with the above example, consider a first scenario where the patient visits the same healthcare provider for a follow-up visit for the same problem condition. The healthcare provider can retrieve the care plan item corresponding to the problem condition from the care plan, review the treatment plan in the care plan item, and revise the treatment plan based on the current diagnosis of the patient and the previous treatment plan. For example, the healthcare provider can determine to change the goal of the treatment, and/or one or more medications of the treatment. The changes made to the care plan item are stored in the care plan. In some embodiments, while the updated care plan item is stored, a previous version of the care plan item is also stored, which can be helpful for a healthcare provider in understanding the various treatments given to the patient over a period of time, and to diagnose the problem condition more comprehensively. In some embodiments, when changes are made to a care plan item, tracking information such as the ID of the user who changed the care plan item, a date and time of the change is also recorded in the care plan.

Continuing with the above example, consider a second scenario where the patient visits a different healthcare provider for a follow-up visit for the same problem condition. The new healthcare provider can retrieve the care plan item, e.g., based on the problem condition, review the treatment plan provided by the previous healthcare provider and other conditions associated with the patient specified in the care plan to become more familiar with the medical history of the patient, and accordingly, diagnose the patient more comprehensively. The healthcare provider can revise the treatment plan based on the current diagnosis of the patient and/or the previous treatment plan. For example, the new healthcare provider can add a new instruction asking the patient to continue with the previously prescribed medication for another course period, to switch to a different medication, or to change the goal of the treatment plan.

Further, the care plan management system includes various features such as recommending a treatment plan, at least in part, based on evidence-based recommendation sources, sending notifications to patients and/or healthcare providers, generating alerts regarding conflicting treatments, automatically updating the status of care plan items, and providing a care team tracker. The evidence-based recommendation sources, e.g., an eCQM (electronic clinical quality measures) source, can be provided by a third-party. In some embodiments, eCQMs use data from electronic health records (EHR) and/or health Information technology systems to measure healthcare quality. CQMs measure healthcare processes, observations, treatments, and outcomes. These measures quantify quality in a healthcare system. Measuring and reporting CQMs helps to make sure that care is delivered safely, effectively, equitably and timely. The eCQMs also include best practices or guidelines to be followed by healthcare providers for providing treatment to the patients. For a given problem condition, the eCQMs can include details of treatment to be provided for different types of patients, the inclusion/exclusion criteria of treatment, etc. A healthcare provider can use a recommended treatment plan generated by the care plan management system for generating a care plan item for the patient. The care plan management system can obtain and/or generate the recommended treatment plan using the evidence-based recommendation source. The care plan management system can retrieve data, e.g., eCQMs, representing recommended treatment plans for various problem conditions for various types of patients from the evidence-based recommendation source and store it in a storage system of the care plan management system. In some embodiments, the care plan management system changes the format of data representing the recommended treatment plans before storing it in the storage system. For example, the care plan management system can parse the retrieved eCQMs and extract one or more of a goal, instructions, medications, order items, notes, etc., and save them to the storage system. When the care plan management system receives a request for generating the recommended treatment, e.g., from a healthcare provider, the care plan management system can retrieve one or more recommended treatment plans from the storage system based on a problem condition and a medical profile associated with patient, e.g., is the patient diabetic, allergic to any medication, age, etc., specified in the request. The care plan management system can present the recommended treatment plans to the healthcare provider for adding them into a care plan item, or the care plan management system can automatically populate the care plan item. The healthcare provider can further customize the care plan item if he/she chooses to do so, e.g., to make the care plan item more specific to the patient.

The care plan management system includes a notification component for generating notifications to notify an occurrence of an event to a concerned entity. For example, the notification component can notify a first healthcare provider, e.g., a primary care physician, when a second healthcare provider, e.g., a specialist, changes the treatment plan generated by the first healthcare provider. The notification component can generate the notification in various ways. For example, the notification component can send an email, a text message, or generate a visual notification in the care plan management system notifying the occurrence of an event.

The care plan management system can include a conflict resolution component that can notify the concerned entity about conflicts in the treatment, e.g., conflicts in medication, instructions, etc.

The care plan management system can also update the status of a care plan item automatically. For example, a care plan item can be associated with a problem condition such as a sprained ankle, and the treatment plan in the care plan item would be suggested for a week's course. During the course of the week, the care plan management system can identify the status of the care plan item as “active.” The care plan management system can automatically update the status to “resolved” after a certain duration post the expiry of the treatment period, e.g., two days of the treatment period, in an event the patient has not consulted the healthcare provider again.

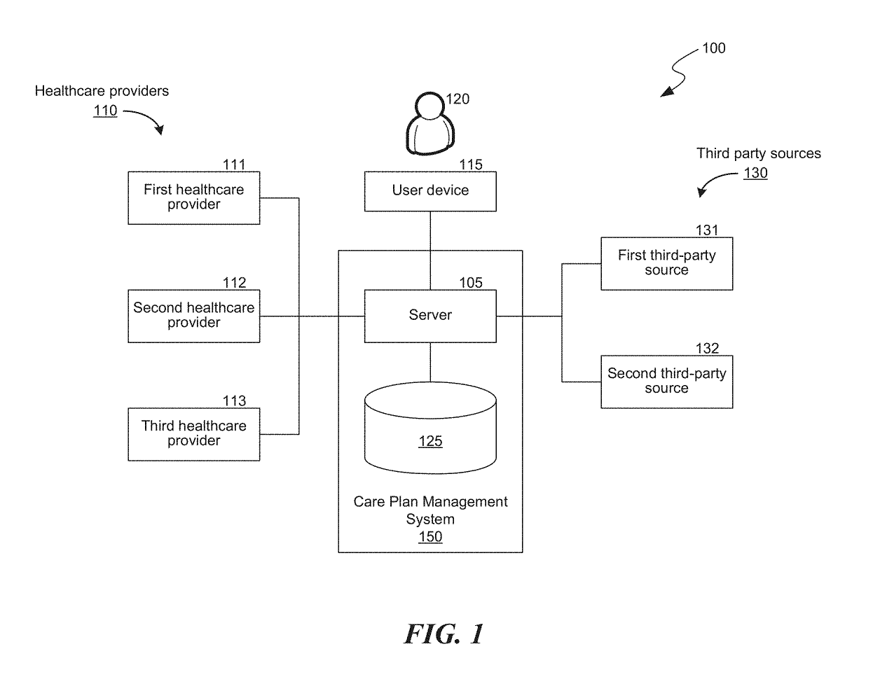

Turning now to the figures, FIG. 1 is a block diagram of an environment 100 in which the disclosed embodiments may be implemented. The environment 100 includes a server 105 and a storage system 125, both of which together form the care plan management system 150 described above. The environment 100 also includes third-party sources 130, e.g., a first third-party source 131 and a second third-party sources 132, that act as evidence-based recommendation sources described above. The healthcare providers 110, e.g., a first healthcare provider 111, a second healthcare provider 112, and a third healthcare provider 113, can access the care plan management system 150 to generate and/or update a care plan for individuals, e.g., patients. For example, a first healthcare provider 111 can use the care plan management system 150 to generate a care plan item that includes a treatment plan for a specified problem condition associated with an individual, e.g., a patient 120. As described above, a healthcare provider can be a facility, such as a clinic, a hospital, an urgent care facility, a laboratory; and/or a healthcare professional, such as a doctor, a surgeon, a lab technician, a nurse. For example, the first healthcare provider 111 is a lab technician, the second healthcare provider 112 is a physician, and the third healthcare provider 113 is a hospital. In some embodiments, the care plan management system 150 restricts the access to the care plans to authorized and/or healthcare providers that are members of the care plan management system 150. A healthcare provider may register with the care plan management system 150 for obtaining membership. In some embodiments, if the member healthcare provider is a facility, access to the care plan management system 150 is provided to some or all of the personnel associated with the facility, e.g., designated personnel. Similarly, the care plan management system 150 restricts access to the care plans to authorized patients, e.g., patients who are members of the care plan management system 150. A patient can register with the care plan management system 150 to access his/her care plan.

The server 105 can implement an application, e.g., a web application that facilitates the management of care plans. The server 105 provides various GUIs, e.g., webpages, for managing the care plans. The healthcare providers can access the application executing at the server 105 via a uniform resource locator (URL) of a webpage of the application. Different GUIs may be provided to the healthcare providers and the patients. For example, a GUI that is designed for a patient may include information that is more easily understandable by the patient. The healthcare providers 110 and/or the patient 120 can access the care plan management system 150 using a computing device that is capable of accessing the care plan management system 150 over a communication network, e.g., Internet, and rendering the GUI to manage the care plans. The computing device can include a desktop, a laptop, a smartphone, a tablet personal computer (PC), etc. In some embodiments, the server 105 implements a client portion of the application that can be installed as an app on a user device 115 to facilitate the patient 120 to access his/her care plans.

The third-party sources 130 provide various types of information, e.g., evidence-based recommendations for treating various problem conditions. For example, the first third-party source 131 can be an evidence-based recommendation source, such as an eCQM source. The eCQMs measure healthcare processes, observations, treatments, and outcomes. These measures quantify quality in a healthcare system. The eCQMs also include best practices or guidelines to be followed by healthcare providers for providing treatment to the patients. For a given problem condition, the eCQMs can include details of treatment to be provided for different types of patients, the inclusion/exclusion criteria of treatment, etc. A healthcare provider can generate a recommended treatment plan using the evidence-based recommendation source.

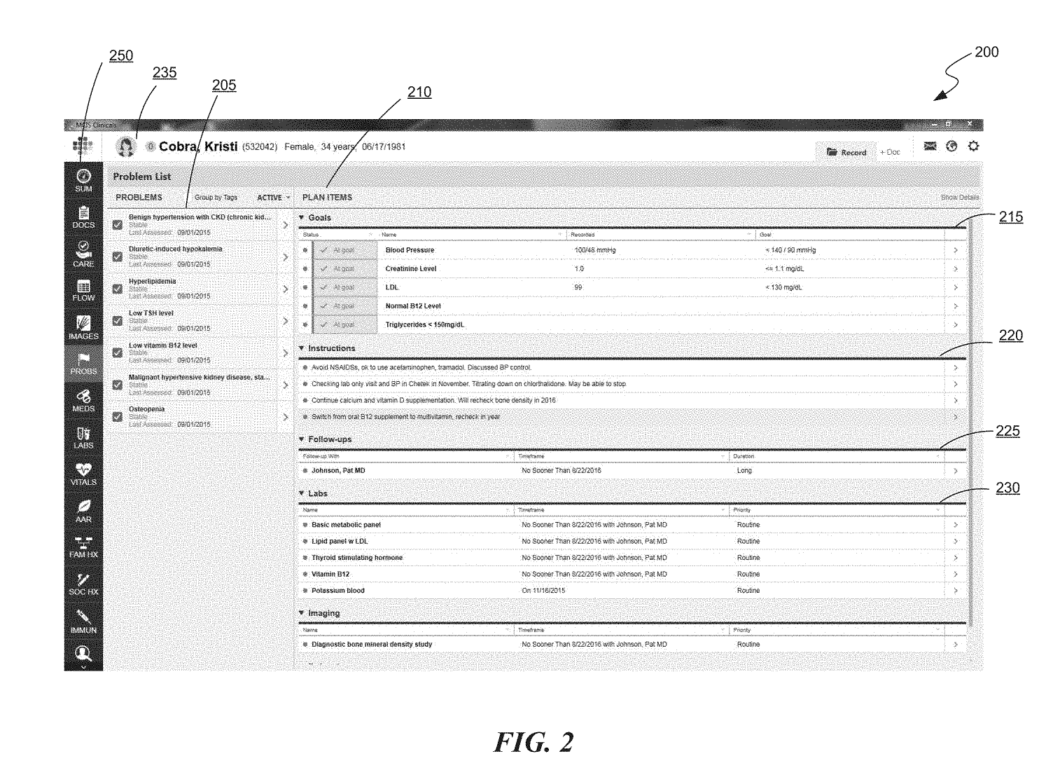

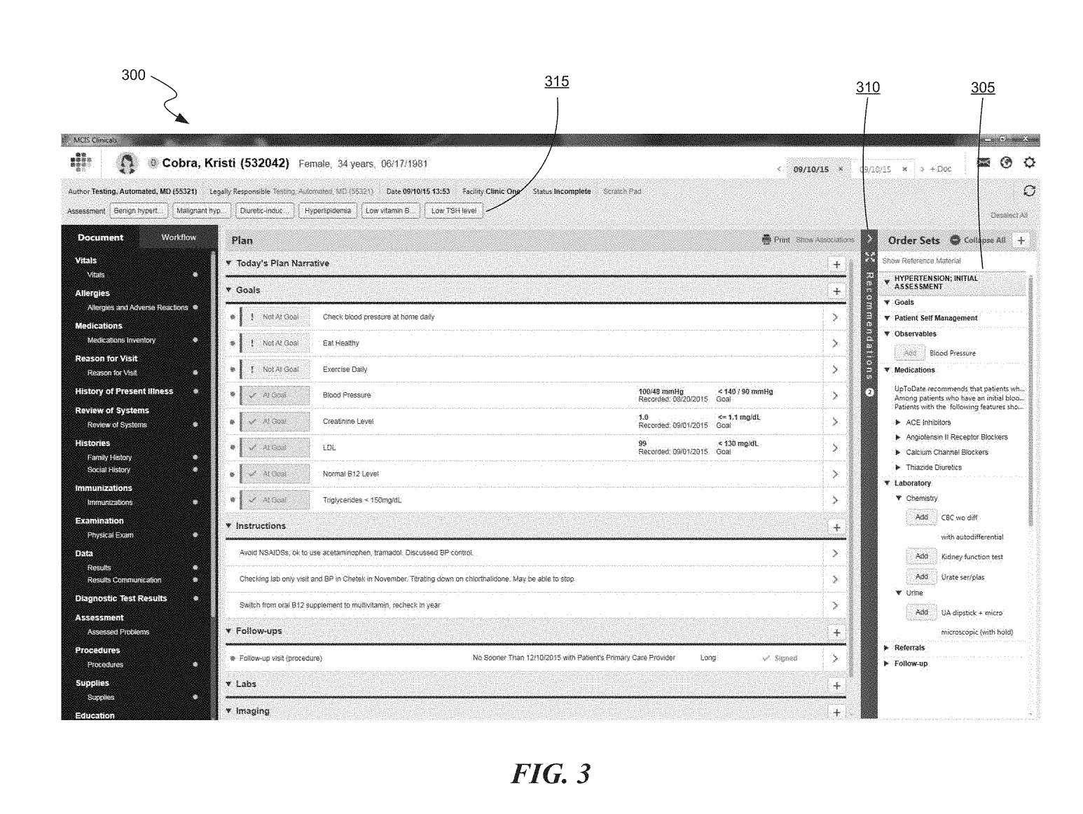

The server 105 facilitates a healthcare provider, e.g., the first healthcare provider 111, to generate a care plan for the patient 120 based on the diagnosis information provided by the first healthcare provider 111. The diagnosis information can include a specified problem condition of the patient 120 diagnosed by the first healthcare provider 111 and a treatment plan for treating the specified problem condition. The server 105 retrieves the care plan associated with the patient 120 from the storage system 125. In some embodiments, each of the patients is assigned a unique patient identifier (ID) and a care plan associated with the patient 120 is assigned a unique care plan ID. The server 105 can retrieve the care plan associated with the patient 120 using the patient ID. If there is no care plan associated with the patient 120, the server 105 can facilitate the healthcare provider to create a new care plan as well as a new care plan item to add the specified problem condition and treatment plan. Additional details with respect to a care plan GUI is described at least with reference to FIGS. 2 and 3. In some embodiments, if the healthcare provider chooses to generate a treatment plan template that contains a recommended treatment for patients, e.g., the patient 120, the server 105 can generate a treatment plan template using the first third-party source 131, which is an evidence-based recommendation source. The server 105 can retrieve a treatment plan template from the first third-party source 131 by specifying the problem condition, e.g., “Benign hypertension with chronic kidney disease,” and one or more parameters from a medical profile of the patient 120, e.g., is the patient diabetic, allergic to any medication, age, etc. The first third-party source 131 returns the recommended treatment plan from which the server 105 can automatically populate the care plan item for the patient 120. Besides the problem condition with which the care plan item is associated, the care plan item can include: (a) one or more goals of the treatment, e.g., maintaining a specified blood pressure, (b) one or more instructions to the patient 120 and/or the healthcare providers 110, e.g., “avoid NSAIDSs, okay to use acetaminophen, tramadol,” (c) an orderable item, e.g., “schedule a follow-up consultation with a specialist,” ordering “a blood test for potassium level,” (d) an observable item, e.g., items to be monitored such as blood pressure, (d) medication for treatment, or (e) additional notes to include any other observations. The first healthcare provider 111 can either accept the care plan item generated based on the recommended treatment or further customize the care plan item if he/she chooses to do so, e.g., to make the care plan item more specific to the patient 120. Additional details with respect to a care plan GUI are described at least with reference to FIGS. 2 and 3.

In some embodiments, if the first healthcare provider 111 does not choose to generate any recommendations for the treatment plan, the first healthcare provider 111 may directly generate the care plan item. For example, the first healthcare provider 111 may input one or more goals, instructions, orderable items, observable items, or medications based on the diagnosis information.

In some embodiments, if the care plan already includes a care plan item that corresponds to the diagnosed problem condition, e.g., one which was generated during one of previous visits of the patient with one of the healthcare providers 110, then the first healthcare provider 111 can review the existing care plan item and revise the treatment plan of the care plan item, if necessary, e.g., based on the diagnosis information. Further, in some embodiments, the server 105 can also facilitate the first healthcare provider 111 to generate a recommended treatment, e.g., as described above, and then add the recommended treatment plan to the existing care plan item.

FIG. 2 is a screenshot of a care plan GUI 200, consistent with various embodiments. The care plan GUI 200 can be used to manage a care plan associated with the patient 120. The care plan GUI 200 includes a number of sections, all of which together provide a medical history associated with the patient 120. The care plan GUI 200 includes an ID section 235 that identifies the patient 120 with which the care plan is associated. The care plan GUI 200 includes a problem condition list 205 that includes a list of “active” problem conditions e.g., problem conditions for which the patient 120 is being treated. While the care plan GUI 200 in FIG. 2 illustrates active problem conditions, the problem condition list 205 can include all of or a subset of the problem conditions associated with the patient 120, e.g., problem conditions that have been “resolved” and problem conditions that have “reoccurred.”

The care plan GUI 200 includes a plan items section 210 that includes a care plan item detailing the treatment for the problem condition selected in the problem condition list 205. The care plan item includes a goal section 215 that specifies one or more goals of the treatment for the selected problem, an instructions section 220 that includes one or more instructions to the patient and/or healthcare providers, and a follow-up section 225 that includes instructions for following up with other healthcare providers, e.g., specialists. The care plan item further includes a labs section 230 that specifies orderable items such as tests to be performed.

The care plan GUI 200 also includes a navigation strip 250 that has links to various sections of the care plan. Some of the sections facilitate management of the medical profile of the patient 120. The navigation strip 250 includes a link to a document section that provides access to a number of documents associated with the patient 120, e.g., lab test results, immunization records, and physical examination results. The server 105 enables the first healthcare provider 111 to upload various documents associated with the patient 120 to this section. For example, the server 105 can facilitate the first healthcare provider 111 to upload a scanned copy of a paper document in the documents section.

The navigation strip 250 includes a “link to images” section that provides access to image documents associated with the patient 120, e.g., X-rays. The server 105 enables the first healthcare provider 111 to upload various images associated with the patient 120 to the images section. For example, the server 105 can facilitate the first healthcare provider 111 to upload an X-ray obtained from an external source, e.g., external to care plan management system 150, to the images section.

The navigation strip 250 includes a link to a medication section that lists medication prescribed for the patient 120 for one or more of the problem conditions. The medication can be filtered based on various criteria, e.g., by the problem condition, by status of the problem condition such as active problems or resolved problems, and date range. Further, each of the medications can also include duration, e.g., five days, for which they have to be taken by the patient 120.

The navigation strip 250 includes a link to a vitals section that has information regarding various vitals of the patient 120, e.g., blood pressure, body temperature, breathing rate, height, and weight.

The navigation strip 250 includes a link to an allergies section that has allergies and adverse reactions information regarding the patient 120.

The navigation strip 250 includes a link to a family history section that includes information regarding medical history of the family of the patient 120, e.g., diseases in the family, and diabetes in the family.

The navigation strip 250 includes a link to a social history section that includes information regarding the social history of the patient 120, e.g., smoking, drinking, and sex with multiple partners.

The navigation strip 250 includes a link to an immunization section that includes immunization information of the patient 120, e.g., vaccinations taken and vaccinations recommended.

Note that the foregoing is not an exhaustive list of the sections that can be incorporated in the care plan GUI 200. The care plan GUI 200 can include additional sections having a variety of information. In some embodiments, the care plan GUI 200 can be customized to include as many sections as necessary to provide a comprehensive medical history for the patient 120 that can be helpful for the healthcare providers 110 in diagnosing the problem condition more comprehensively and therefore, for providing a quality healthcare.

Note that information in some of the sections of the care plan GUI 200 can be input by the healthcare providers 110 or by the patient 120. For example, the patient 120 can provide information such as allergies and adverse reactions, immunization information, and vitals.

The server 105 can provide access to the entire care plan associated with the patient 120, e.g., all the care plan items associated with all the problem conditions associated with the patient 120, to all the healthcare providers 110. Sharing access to the care plan of the patient 120 with multiple healthcare providers 110 is beneficial and valuable because, even if the patient 120 visits a new healthcare provider that he/she has not visited before, the healthcare provider can review the medical history in one single place, e.g., the care plan in the care plan management system 150, and diagnose the problem condition of the patient more effectively. Further, any of the healthcare providers may revise a care plan item associated with the patient 120. For example, consider that the patient 120 initially visits the first healthcare provider 111 to be treated for the problem condition “Benign hypertension with chronic kidney disease” displayed in the problem condition list 205, and the first healthcare provider 111 generates the care plan item displayed in the plan items section 210. Now consider that the patient 120 visits another healthcare provider for the same problem condition. The server 105 can provide access for the care plan item generated by the first healthcare provider 111 to the other healthcare provider. The other healthcare provider can review the care plan item, diagnose the patient 120 accordingly, and revise the care plan item based on his/her diagnosis of the patient 120.

FIG. 3 is a screenshot of a care plan GUI 300 illustrating generating recommendations for treatment and adding the recommendations to a care plan, consistent with various embodiments. The server 105 generates a treatment plan template that includes recommended treatments for one or more problem conditions associated with the patient 120. The care plan GUI 300 illustrates a recommendation section 305 that includes a treatment plan template having recommended treatments for the problem conditions 315. The first healthcare provider 111 can access the recommendation section 305 using a recommendation link 310. The recommendation section 305 can include a recommendation of one or more of goals, instructions, follow-up information, observation items, or orderable items such as lab tests, etc. The server 105 can generate the recommendations using an evidence-based recommendation source and the medical profile of the patient 120, e.g., problem conditions, allergies, vitals, and age.

The server 105 and/or the first healthcare provider 111 can add the items from the recommendation section 305 to the care plan. For example, the server 105 can automatically add one or more of the above items from the recommendation section 305 to the care plan of the patient 120. In the care plan GUI 300, the goal of “Blood pressure—<140/90 mmHg>” is automatically added to the care plan by the server 105. Further, in some embodiments, when a goal is added, the server 105 also computes the status of the goal automatically, e.g., whether patient 120 has met the goal or not, based on the information available from the care plan. For example, for the blood pressure goal, the server 105 can retrieve any recorded blood pressure values of the patient 120, which can be included as part of vital information of the patient 120, compare the recorded value with values provided in the goal, and then compute the status of the goal, e.g., “at goal” or “not at goal,” based on the comparison result. In some embodiments, the server 105 can also indicate the date on which the particular values are recorded.

In some embodiments, the first healthcare provider 111 can also add any of the recommended items to the care plan of the patient 120, or even modify the recommended items automatically added by the server 105. For example, the first healthcare provider 111 can add one or more of the recommended lab tests. In another example, the first healthcare provider 111 can also change or delete a particular lab test automatically added by the server 105.

In some embodiments, when a recommended item is added to the care plan by the server 105 and/or the first healthcare provider 111, the item is added to a care plan item that is associated with a specified problem condition. Continuing with the above of example of the blood pressure goal added to care plan by the server 105, the server 105 can add the blood pressure goal to the care plan item associated with the problem condition “Benign hypertension with chronic kidney disease.”

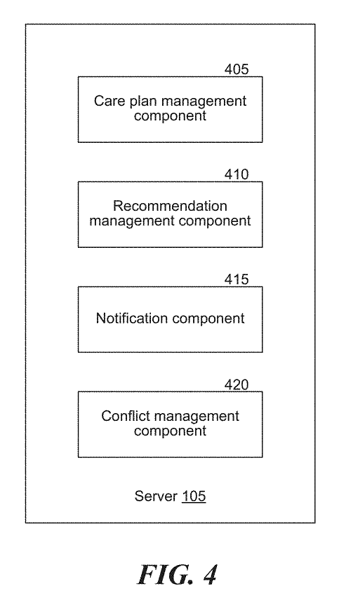

FIG. 4 is a block diagram of the server 105 of FIG. 1, consistent with various embodiments. The server 105 includes a care plan management component 405 that facilitates managing a care plan associated with the patient 120, e.g., adding, modifying or deleting a care plan item associated with the patient. The care plan management component 405 can retrieve and/or store the care plan in the storage system 125. The care plan management component 405 also facilitates managing, e.g., receiving, retrieving and/or storing the medical profile of the patient 120, such as immunization records, vital information, family history, allergies, etc.

The server 105 includes a recommendation management component 410 that facilitates generating treatment recommendations for one or more problem conditions associated with the patient 120, e.g., as described above at least with reference to FIGS. 1 and 3. The recommendation management component 410 interfaces with the third-party sources 130 to retrieve the recommendations, best practices, healthcare guidelines, etc. from the third-party sources 130 and store them in the storage system 125 of the care plan management system 150. The recommendation management component 410 also keeps the storage system 125 updated with the latest version of the foregoing information as and when the information is provided by or is changed in any of the third-party sources 130.

Different third-party sources 130 can store the information in different formats. The recommendation management component 410 can include an interface component for each of the third-party sources 130 that enables the server 105 to retrieve the data from the corresponding third-party source, then convert and store it in a format for use by the care plan management system 150. For example, the recommendation management component 410 can retrieve data, e.g., eCQMs, from the evidence-based recommendation source that represents recommended treatment plans for various problem conditions for various types of patients, convert the data into a format suitable for adding to the care plan, and store it in the storage system 125. The eCQMs can include details of treatment to be provided for different problem conditions and different types of patients, i.e., the inclusion/exclusion criteria of treatment, etc. One example of converting the format of the eCQMs to the care plan item format is the parsing of the retrieved eCQMs to identify one or more parts of a care plan item, e.g., a goal, instructions, medications, order items, observable items, notes, etc., and extracting the identified items. The extracted items are then stored in the storage system 125 as a treatment recommendation plan template. The recommendation management component 410 can assign a unique template ID to each of the treatment recommendation plan templates and then associate the template ID with one or more problem condition IDs, and associate the treatment recommendation template to one or more problem conditions. In some embodiments, the treatment recommendation template can also be associated with various medical profile IDs to indicate that the treatment recommendation template is for a patient with a particular medical profile.

When the care plan management system 150 receives a request for generating a recommended treatment, e.g., from a healthcare provider, the recommendation management component 410 can retrieve one or more recommended treatment plans from the storage system 125 based on the problem condition and the medical profile of the patient specified in the request. The recommendation management component 410 can present the retrieved recommended treatment plans to the healthcare provider for adding them into a care plan item, or the recommendation management component 410 can automatically populate the care plan item, for example, as described at least with reference to care plan GUI 300.

The server 105 includes a notification component 415 for notifying a targeted entity regarding an event. Examples of an event include (a) change in status of a problem condition, (b) availability of a test result, (c) conflict in medication and/or instructions, (d) rescheduling of an appointment, (e) availability status of medication, and (f) completion of medical profile. The notification can be an email, text message, telephone call, notification via a mobile app, a visual notification in the care plan GUI, or other methods of communication.

As an example, a first healthcare provider 111 may generate a care plan item for treating a specified problem condition associated with the patient 120. When the patient 120 visits another healthcare provider, such as the second healthcare provider 112, for the same problem condition or even for a different problem condition, the second healthcare provider 112 may change the care plan item generated by the first healthcare provider 111. In some embodiments, the notification component 415 can notify a change in the care plan item to the originator of the care plan item, e.g., to the first healthcare provider 111 and, optionally, to the patient 120.

The notification component 415 can notify a healthcare provider and/or the patient 120 when results of a particular lab test are uploaded to the care plan of the patient 120. The notification component 415 can notify the patient 120 regarding availability or non-availability of a prescribed medicine at a pharmacy associated with the prescribing healthcare provider and/or care plan management system 150. In some embodiments, the pharmacy can be one of the third-party sources 130.

The server 105 includes a conflict management component 420 that determines a conflict in the care plan. The conflict management component 420 determines conflicts in the care plan, such as conflicts in medication or instructions to the patient, and alerts the notification component 415 to notify a relevant party regarding the conflict. For example, when a healthcare provider prescribes to a patient a particular medication that conflicts with another medication already prescribed, or if the patient has an allergy to the medication, the conflict management component 420 identifies a conflict and alerts the notification component 415 to notify the healthcare provider and/or the patient 120 regarding the conflict. In another example, when a healthcare provider includes an instruction that conflicts with another instruction in any of the care plan items already prescribed, the conflict management component 420 identifies the conflict and alerts the notification component 415 to notify the healthcare provider and/or the patient 120 regarding the conflict. In some embodiments, the conflict management component 420 identifies the conflict using the knowledge gained from the third-party sources 130, such as eCQMs.

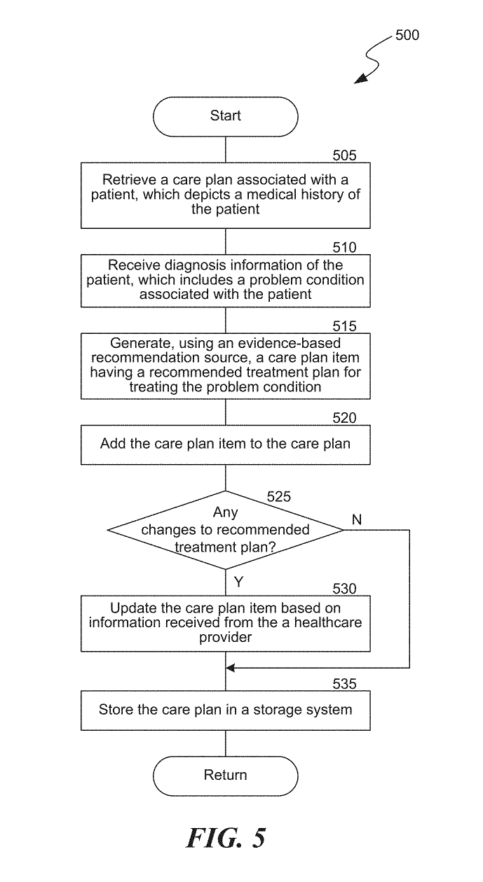

FIG. 5 is a flow diagram of a process 500 for generating a care plan item for treating a patient's specified problem condition, consistent with various embodiments. In some embodiments, the process 500 may be implemented in the environment 100 of FIG. 1. At block 505, the care plan management component 405 retrieves a care plan associated with the patient from the storage system 125 of the care plan management system 150. The care plan depicts a medical history of the patient. In some embodiments, a care plan is associated with a unique patient ID that identifies the patient. The care plan management component 405 can retrieve the care plan associated with the patient from the storage system 125 using a patient ID received in a request, e.g., from a healthcare provider, such as a doctor who is diagnosing the patient. In some embodiments, the care plan management component 405 can output the care plan in a GUI, such as the care plan GUI 200, on a computing device.

At block 510, the care plan management component 405 receives the patient's diagnosis information from the healthcare provider. The diagnosis information can include a problem condition associated with the patient, e.g., “Benign hypertension with chronic kidney disease.” In some embodiments, the diagnosis information can also include one or more parameters of a medical profile of the patient, e.g., immunization records, vital information, family history, allergies, etc. Some parameters of the medical profile may already be stored in the care plan.

At block 515, the recommendation management component 410, using an evidence-based recommendation source, generates a care plan item having a recommended treatment plan for treating the problem condition of the patient. The evidence-based recommendation source includes data representing recommended treatment plans for various problem conditions for various types of patients. In some embodiments, the recommendation management component 410 populates the storage system 125 with the recommended treatment plans from the evidence-based recommendation source prior to generating a recommended treatment plan. When the care plan management component 405 receives a request from the healthcare provider to generate a recommended treatment plan for treating a particular problem condition of a patient, the recommendation management component 410 retrieves a care plan item from the storage system 125 which matches the particular problem condition and the particular medical profile of the patient specified in the request.

At block 520, the recommendation management component 410 automatically adds the care plan item to the care plan. In some embodiments, adding the care plan item to the care plan includes adding items such as one or more of a goal of the treatment, instructions regarding the treatment (e.g., instructions to the patient and/or healthcare provider), follow-up information, an orderable item (e.g., a lab test), or a note (e.g., to the healthcare provider and/or the patient).

At determination block 525, the care plan management component 405 determines if there were any changes made by the healthcare provider to the care plan item. If no changes were made at block 535, the care plan management component 405 stores the care plan in the storage system 125, and the process 500 returns. However, if any changes were made to the recommended treatment plan, e.g., the goal and/or an instruction was updated, at block 530, the care plan management component 405 updates the care plan item accordingly, and, at block 535, stores the care plan in the storage system 125.

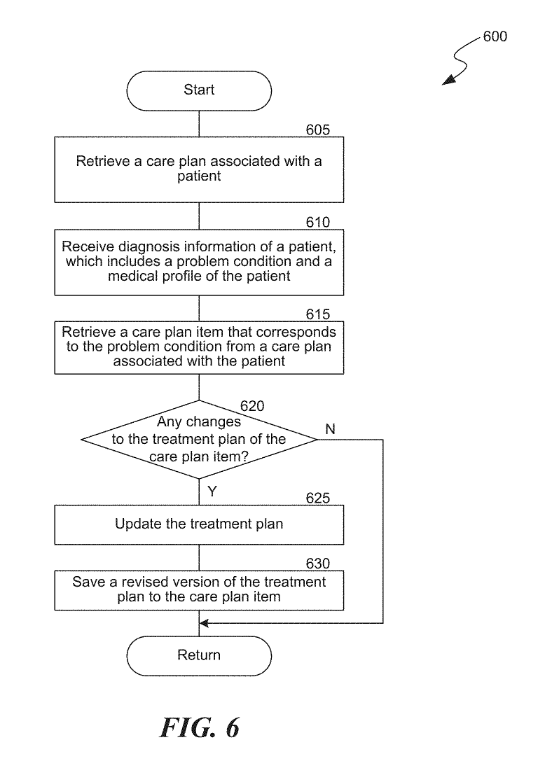

FIG. 6 is a flow diagram of a process 600 for updating a care plan item of a care plan, consistent with various embodiments. In some embodiments, the process 600 may be implemented in the environment 100 of FIG. 1. The process 600 can be executed by the server 105 in a scenario where a patient is visiting a first healthcare provider for a follow-up treatment for a problem condition, or visiting a second healthcare provider for obtaining treatment for the same problem condition. At block 605, the care plan management component 405 retrieves a care plan associated with the patient from the storage system 125. At block 610, the care plan management component 405 receives diagnosis information of the patient from the healthcare provider. The diagnosis information can include a problem condition associated with the patient, e.g., “benign hypertension with chronic kidney disease.” In some embodiments, the diagnosis information can also include one or more parameters of a medical profile of the patient, e.g., immunization records, vital information, family history, allergies, etc. Some parameters of the medical profile may already be stored in the care plan.

At block 615, the care plan management component 405 retrieves a care plan item associated with the problem condition from the care plan.

At determination block 620, the care plan management component 405 determines if there were any changes made to the care plan item, e.g., by the healthcare provider. If no changes were made, the process 600 returns. On the other hand, if the healthcare provider made any changes to the treatment plan, e.g., updated the goal and/or an instruction, at block 625, the care plan management component 405 updates the care plan item accordingly. At block 630, the care plan management component stores a revised version of the care plan item in the care plan.

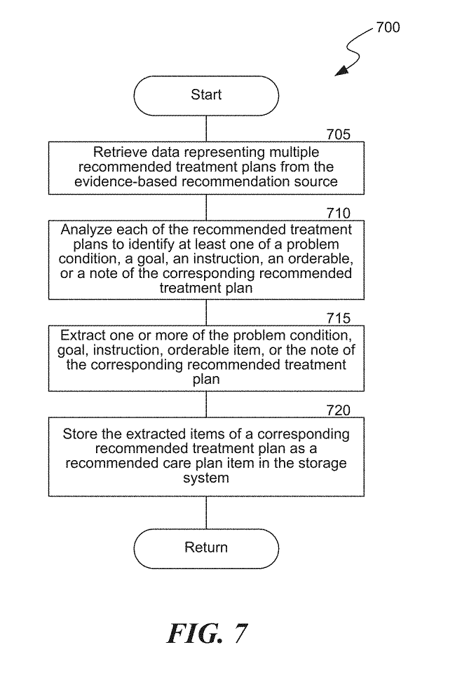

FIG. 7 is a flow diagram of a process 700 for populating a care plan management system of FIG. 1 with recommended treatment plans from a third-party source, consistent with various embodiments. In some embodiments, the process 700 may be implemented in the environment 100 of FIG. 1. A third-party source can provide treatment recommendations, best practices in providing quality healthcare, healthcare guidelines, etc. The server 105 interfaces with the third-party sources 130 to fetch the recommendations, best practices, healthcare guidelines, etc. Different third-party sources 130 can store the information in different formats. For example, the first third-party source 131 can be an evidence-based recommendation source that stores recommendations as eCQMs. The eCQMs can include details of treatment to be provided for different problem conditions and different types of patients, the inclusion/exclusion criteria of treatment, etc. The server 105 converts the eCQMS to a specified format, e.g., care plan items as more fully described below.

At block 705, the recommendation management component 410 retrieves data representing recommended treatment plans from the first third-party source 131. The recommended treatment plans can be for various problem conditions and for various types of patients, e.g., patients having different medical profiles.

At block 710, the recommendation management component 410 analyzes data representing each of the recommended treatment plans to identify one or more parts of a care plan item, e.g., a problem condition, a goal, instructions, medications, order items, observable items, notes, etc.

At block 715, the recommendation management component 410 extracts the identified items for each of the recommended treatment plans.

At block 720, the recommendation management component 410 stores, for each of the recommended treatment plans, the extracted items as a recommend care plan item in the storage system 125.

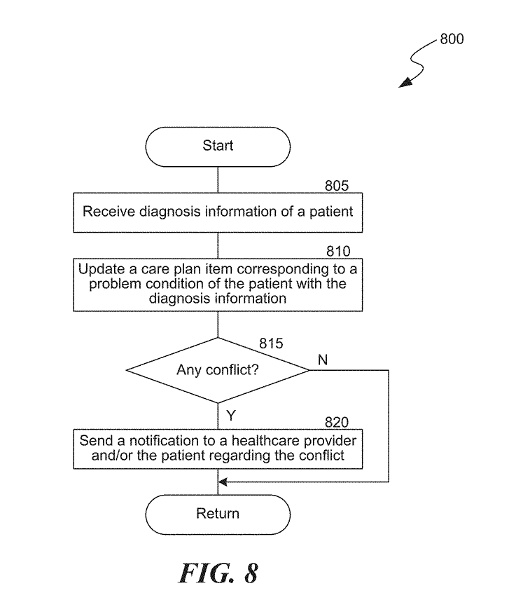

FIG. 8 is a flow diagram of a process 800 for determining a conflict in the care plan, consistent with various embodiments. In some embodiments, the process 800 may be implemented in the environment 100 of FIG. 1. At block 805, the care plan management component 405 receives diagnosis information of a patient from a healthcare provider. The diagnosis information can include a problem condition associated with the patient and any treatment information such as medications or instructions. In some embodiments, the diagnosis information can also include one or more parameters of a medical profile of the patient such as immunization records, vital information, family history or allergies. Some parameters of the medical profile may already be stored in the care plan.

At block 810, the care plan management component 405 updates the care plan item based on the diagnosis information provided by the healthcare provider.

At determination block 815, the conflict management component 420 determines if there is any conflict in the care plan due to the updated care plan item. In some embodiments, the conflict management component 420 can determine conflicts in the care plan with the updated care plan item. For example, when a healthcare provider prescribes a particular medication, the particular medication may conflict with another medication already prescribed, or the patient may be allergic to the medication. In another example, the updated care plan item may include conflicting instruction that conflicts with another instruction in the care plan.

If the conflict management component 420 does not determine a conflict, the process 800 returns. On the other hand, if the conflict management component 420 determines a conflict at block 820, then conflict management component 420 alerts the notification component 415, which can notify the healthcare provider and/or the patient 120 regarding the conflict.

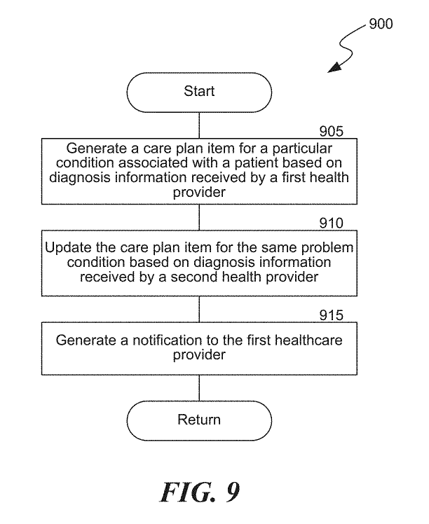

FIG. 9 is a flow diagram of a process 900 for generating a notification of an occurrence of an event in the care plan, consistent with various embodiments. In some embodiments, the process 900 may be implemented in the environment 100 of FIG. 1. At block 905, the care plan management component 405 generates a care plan item which includes a treatment plan for a problem condition of a patient. The care plan management component 405 generates the care plan item based on patient diagnosis information received from a first healthcare provider 111, e.g., a primary care physician. In some embodiments, the care plan management component 405 generates the care plan item as described at least with reference to FIGS. 1-3, 5 and 6.

At block 910, the care plan management component 405 updates the care plan item based on diagnosis information of the patient received from a second healthcare provider 112, such as a specialist. In some embodiments, the care plan management component 405 updates the care plan item as described at least with reference to FIGS. 1-3 and 6.

At block 915, the notification component 415 generates a notification notifying the first healthcare provider 111 of a change to the care plan item that was authored by that first healthcare provider 111. The notification component 415 can generate the notification in various ways, such as an email, text message, or visual notification, e.g., in the care plan GUI in association with the care plan item that has changed, notifying the first healthcare provider 111 of occurrence of an event.

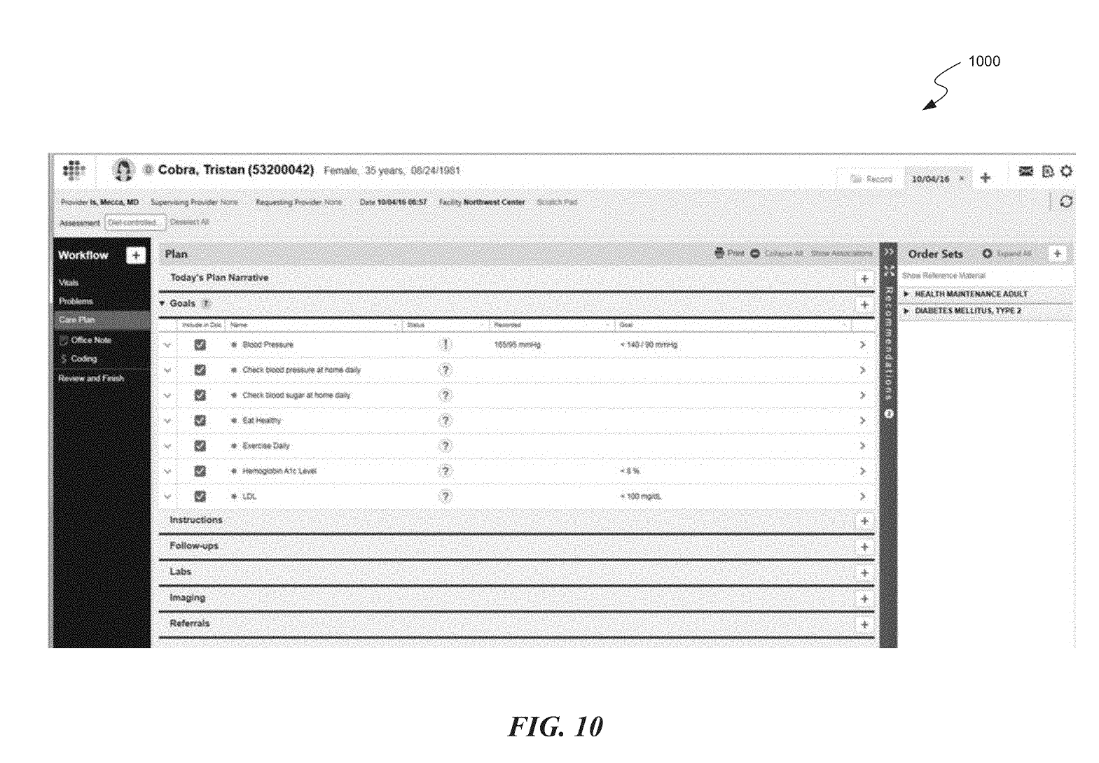

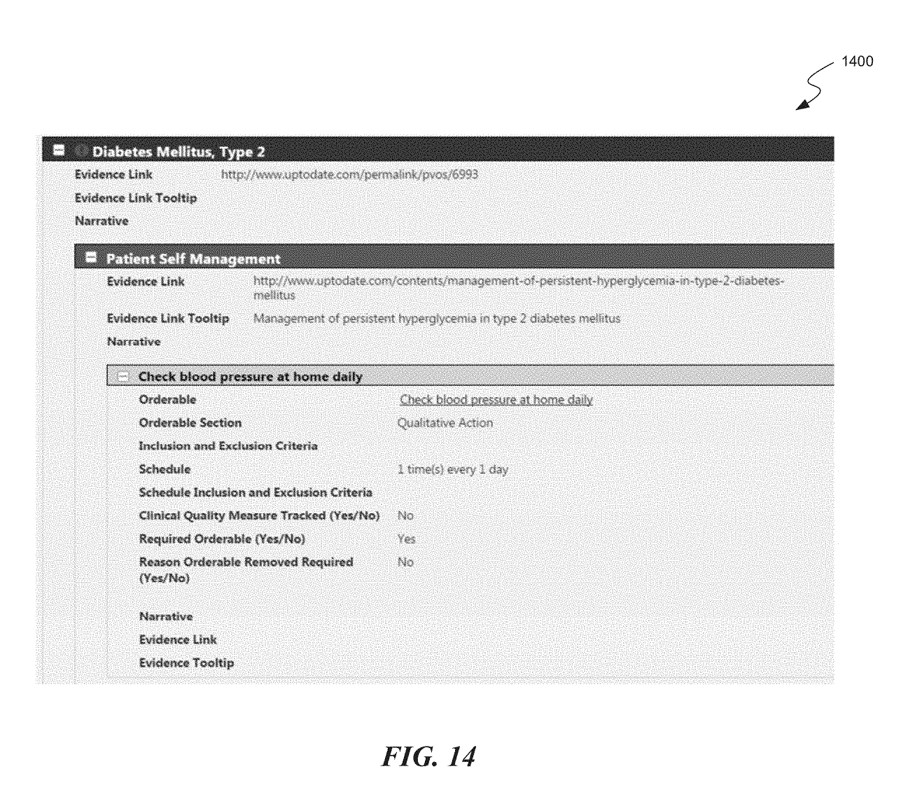

FIG. 10 is a screenshot of a care plan GUI 1000, consistent with various embodiments. The care plan GUI 1000 can be used to manage a care plan associated with the patient 120. In some embodiments, the care plan GUI 1000 is similar to the care plan GUI 200 of FIG. 2. The care plan GUI 1000 depicts a GUI to which care plan items can be added for the patient 120. In some embodiments, the goals added to the goals section were flagged as “required care plan items” in an admin tool (e.g., illustrated in FIG. 14) for a patient diagnosed with a specified condition, e.g., Diabetes Mellitus, Type 2, which results in these items being automatically added to the patient's care plan when the healthcare provider identifies or inputs the problem condition of the patient 120 as diabetes. In some embodiments, the admin tool can receive information regarding the required care plan items from third-party sources 130 and/or healthcare providers 110. The “Recommendations” section can show the clinically relevant, evidence-based care plan items such as goals, labs, imaging orders, etc.

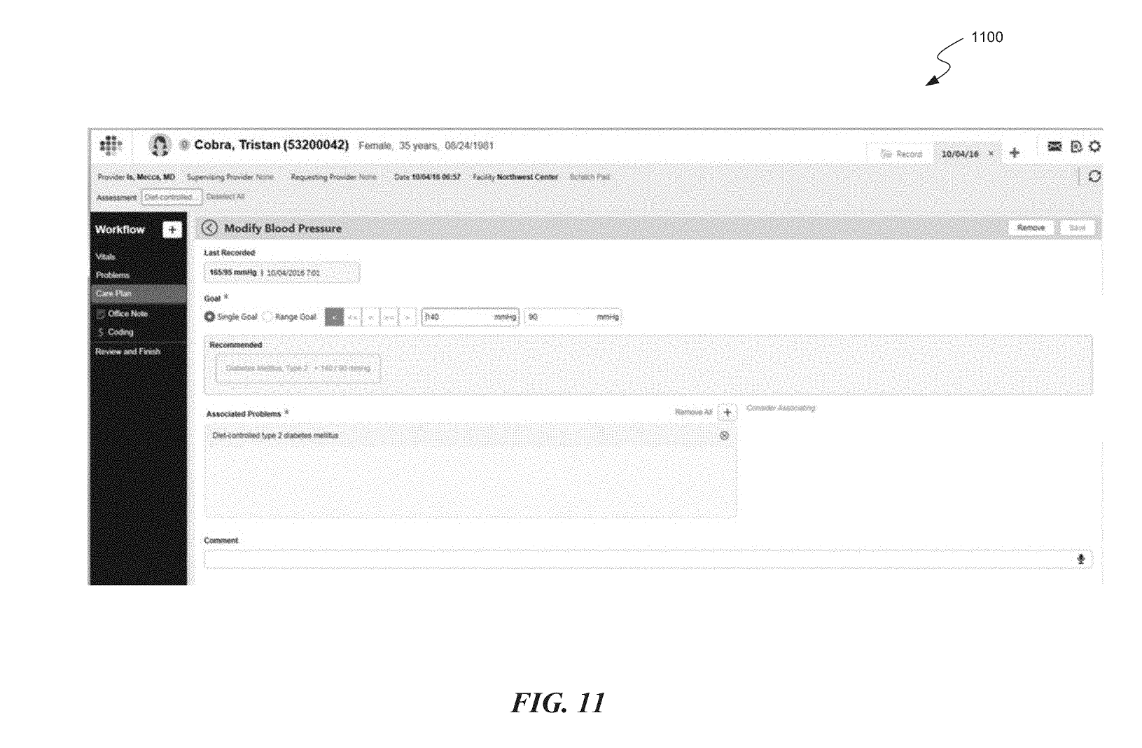

FIG. 11 is a screenshot of a care plan GUI 1100, consistent with various embodiments. The care plan GUI 1100 can be used to manage a care plan associated with the patient 120. In some embodiments, the care plan GUI 1100 can be navigated to from the care plan GUI 1000 of FIG. 10. The care plan GUI 1100 shows the ability to set patient-specific goals. For example, the server 105 may recommend a specific goal such as “Blood Pressure 140/90.” The healthcare provider may accept the recommended goal or choose to override the recommended goal.

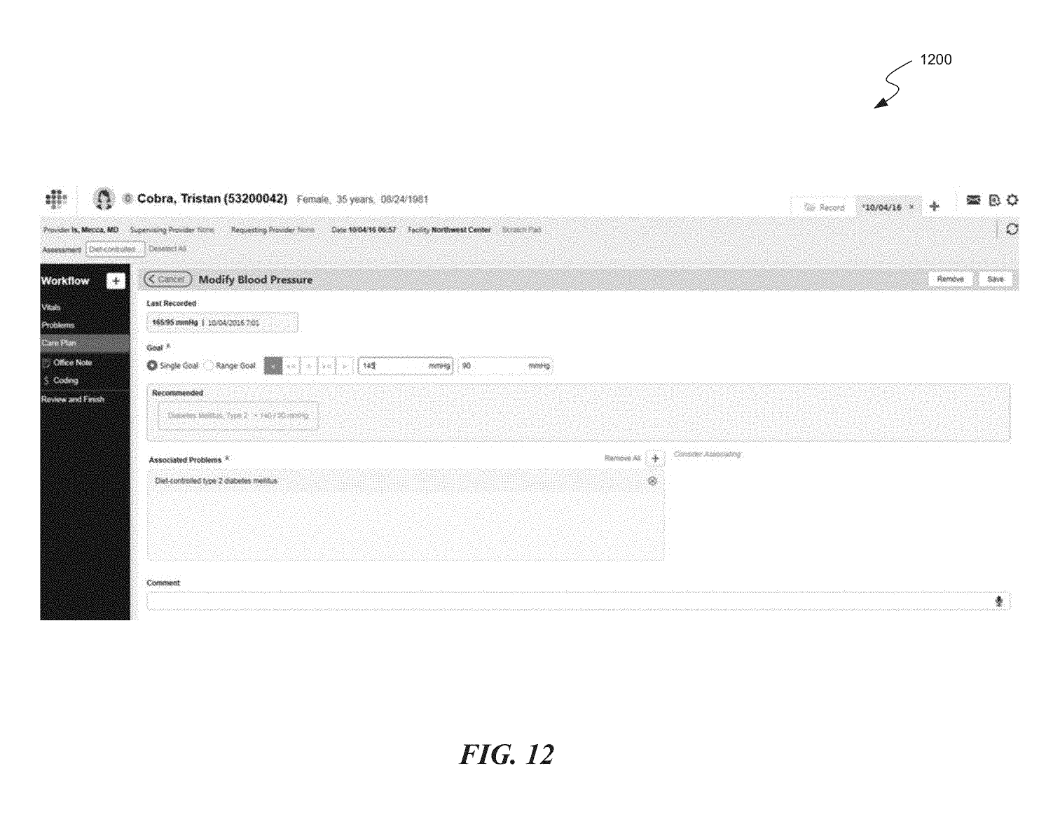

FIG. 12 is a screenshot of a care plan GUI 1200, consistent with various embodiments. The care plan GUI 1200 can be used to manage a care plan associated with the patient 120. In some embodiments, the care plan GUI 1200 is similar to the care plan GUI 1100 of FIG. 11. The care plan GUI 1200 illustrates the server 105 recommending “Blood Pressure” goal of “140/90” and being overridden to “145/90” by the healthcare provider.

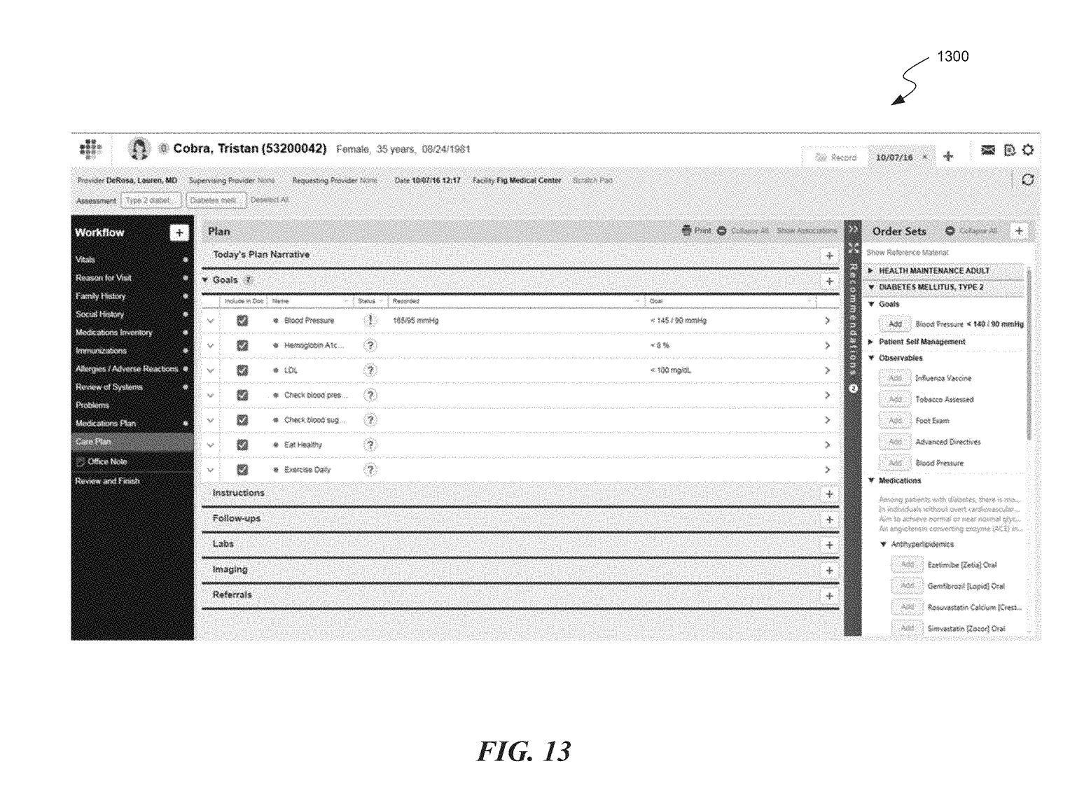

FIG. 13 is a screenshot of a care plan GUI 1300, consistent with various embodiments. The care plan GUI 1300 can be used to manage a care plan associated with the patient 120. In some embodiments, the care plan GUI 1300 is similar to the care plan GUI 200 of FIG. 2. The care plan GUI 1300 depicts the care plan of the patient 120, including care plan items for one or more conditions identified for the patient. The care plan GUI 1300 shows various goals added to the care plan of the patient 120 and recommendations generated by the server 105 for the patient 120 in the “Recommendations” section.

FIG. 14 is a screenshot 1400 of an admin tool of the care plan management system, consistent with various embodiments. In some embodiments, the admin tool is used to manage the evidence-based rules that are used to generate recommendations for various problem conditions. The screenshot 1400 depicted in FIG. 14 shows the rules used for generating specific evidence-based goal recommendations for a specific problem condition such as type 2 diabetes mellitus. These rules can be applied in addition to the rules provided by the third-party sources 130 for generating the recommendations. In some embodiments, a user, e.g., a healthcare provider or another operator associated with the server 105, can program the admin tool with various rules.

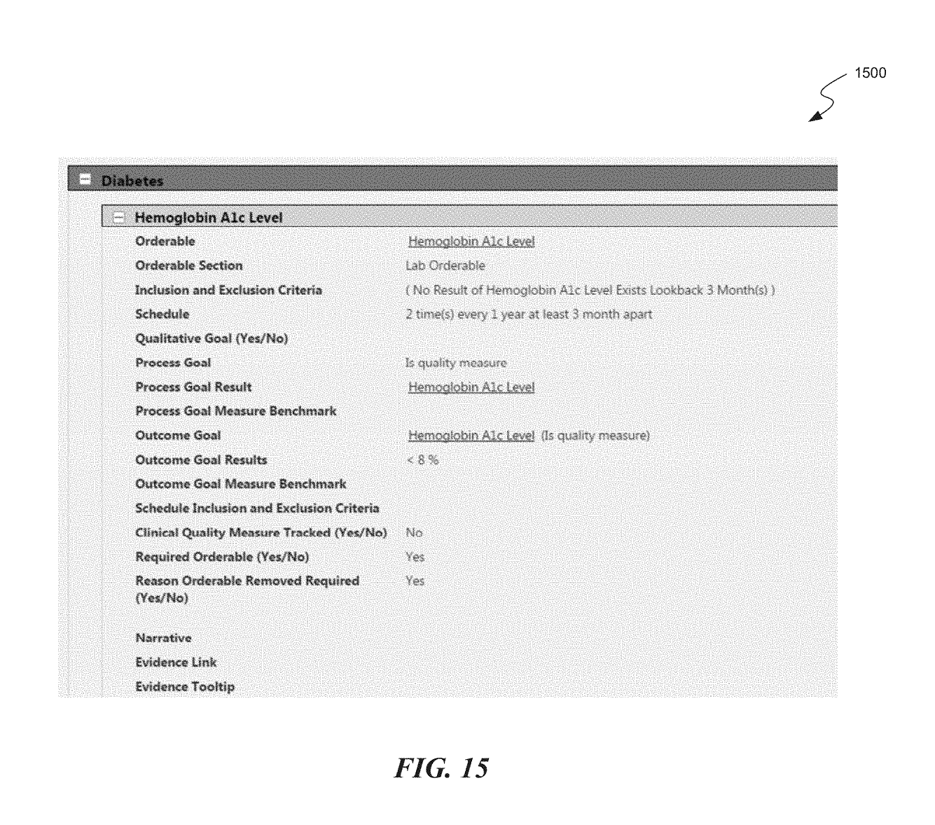

FIG. 15 is screenshot 1500 of the admin tool, consistent with various embodiments. The screenshot 1500 illustrates the rules based on which the server 105 generates an evidence-based lab recommendation specifically for Hemoglobin A1c trigger for a diabetic patient.

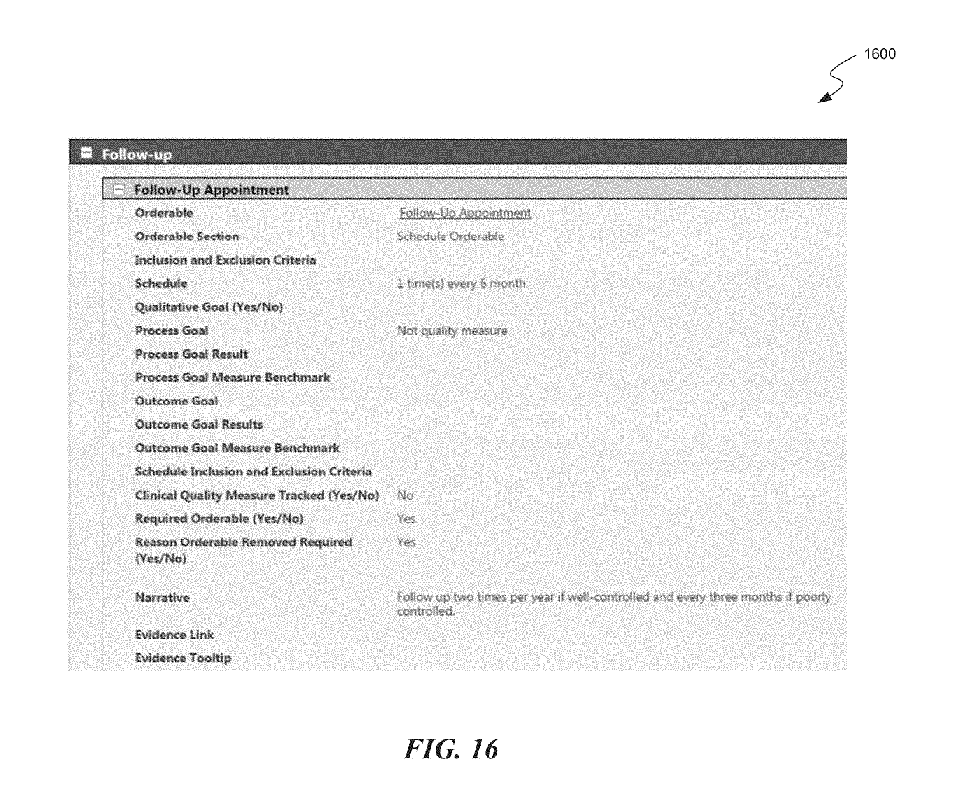

FIG. 16 is screenshot 1600 of the admin tool, consistent with various embodiments. The screenshot 1600 illustrates the rules based on which the server 105 generates a evidence-based “follow-up” orders recommendations for the diabetic patient.

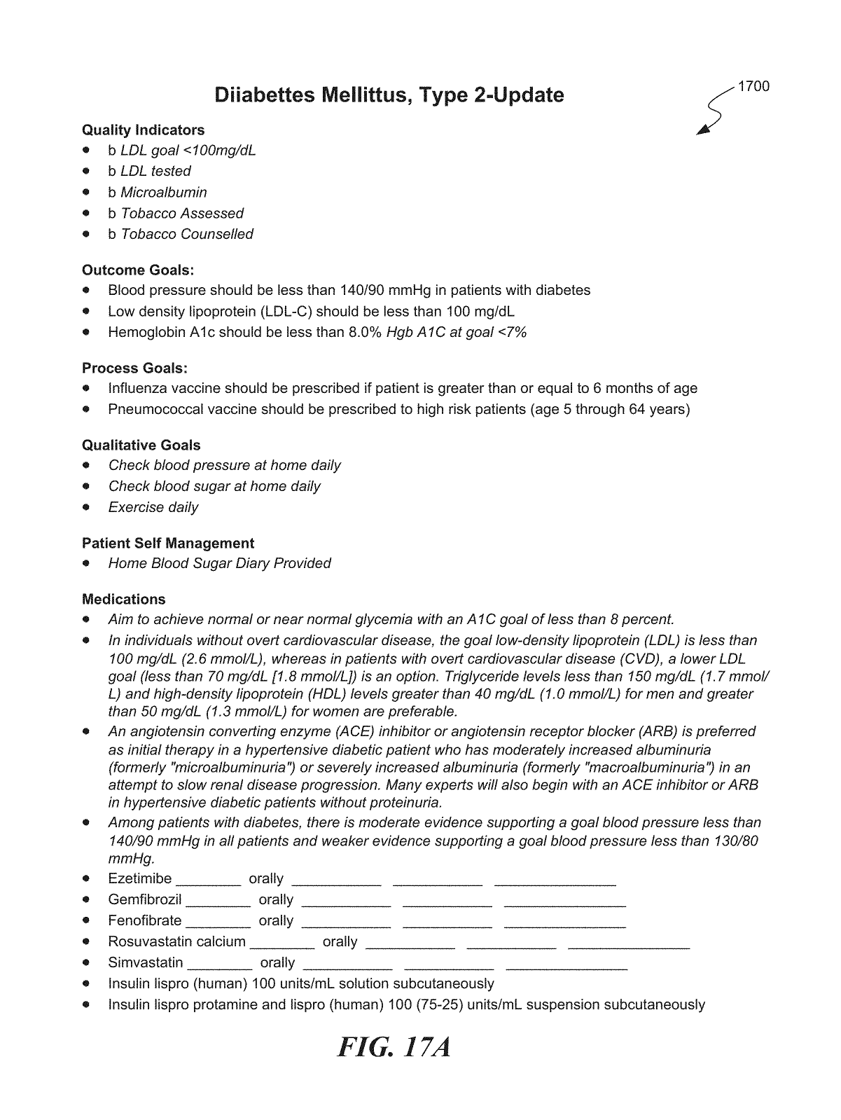

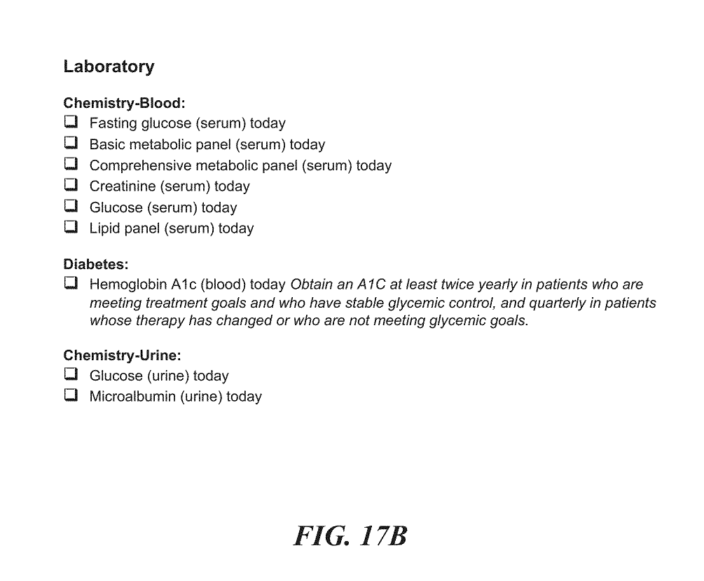

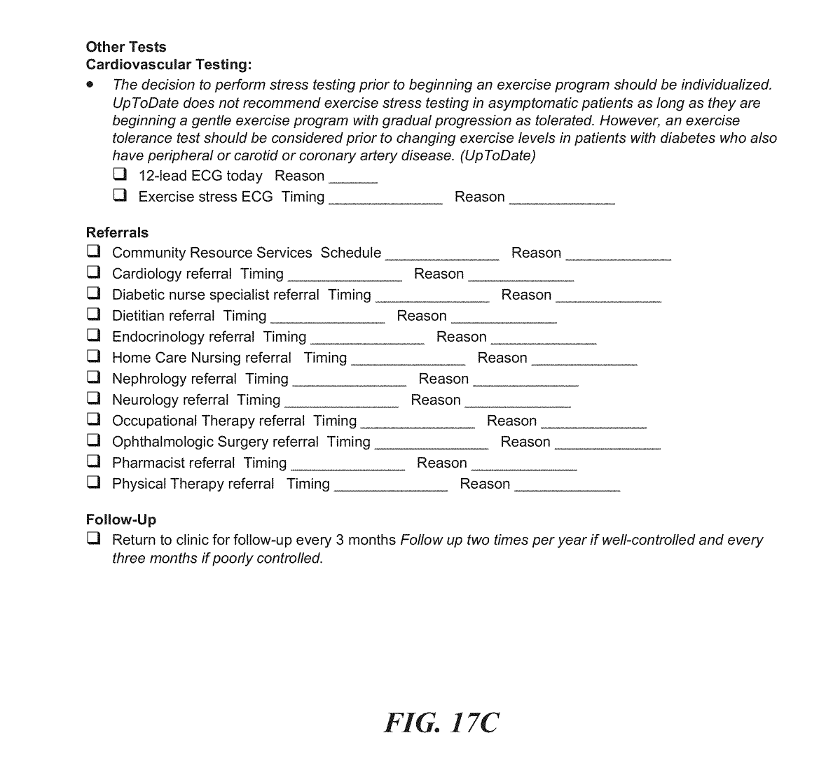

FIGS. 17A-17C illustrate screenshots of an evidence-based recommendation template received from third-party sources 130, consistent with various embodiments. In some embodiments, the evidence-based recommendation template 1700 is a template that can be used to generate recommendations for a specific problem condition, such as type 2 diabetes mellitus. The recommendation template 1700 can be provided by the first third-party source 131. As described earlier, different providers can provide the recommendations in different formats. The server 105 includes an interface component for each of the various formats that can analyze the received recommendation template, extract necessary items from the recommendation template, and store them as a recommendation care plan item in the storage system 125. For example, the server 105 can analyze the recommendation template 1700 and extract the goals, medications, lab tests, follow-up orders, triggers (quality indicators) that trigger specific recommendations, etc., and store them as care plan items. The server 105 provides an admin tool, e.g., as illustrated in the FIGS. 14-16, that allows the user to customize the rules for generating the recommendations. The server 105 can use the recommended care plan items retrieved from the recommendation template 1700 to generate the recommendations. A user, e.g., the healthcare provider, can request the server 105 to generate the recommendations, e.g., in the “Recommendations” section of the care plan GUI 300 and/or 1000, and can also further customize the generated recommendations, e.g., as illustrated in the care plan GUI 1200.

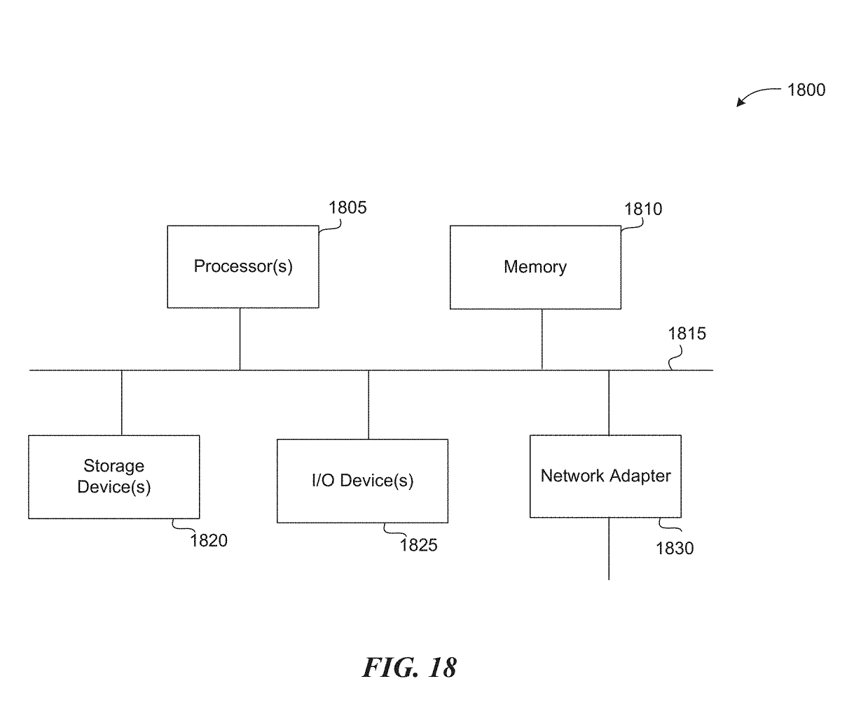

FIG. 18 is a block diagram of a computer system as may be used to implement features of the disclosed embodiments. The computing system 1800 may be used to implement any of the entities, components, modules, systems, or services depicted in the examples of the foregoing figures (and any other entities described in this specification). The computing system 1800 may include one or more central processing units (“processors”) 1805, memory 1810, input/output devices 1825 (e.g., keyboard and pointing devices, display devices), storage devices 1820 (e.g., disk drives), and network adapters 1830 (e.g., network interfaces) that are connected to an interconnect 1815. The interconnect 1815 is illustrated as an abstraction that represents any one or more separate physical buses, point to point connections, or both connected by appropriate bridges, adapters, or controllers. The interconnect 1815, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1810 and storage devices 1820 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media).

The instructions stored in memory 1810 can be implemented as software and/or firmware to program the processor(s) 1805 to carry out actions described above. In some embodiments, such software or firmware may be initially provided to the processing system 1800 by downloading it from a remote system through the computing system 1800 (e.g., via network adapter 1830).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a specified feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A computer-implemented method, comprising:
retrieving, by a computer system and from a storage system, a care plan associated with a patient, wherein the care plan includes multiple care plan items in which each of the care plan items has (a) a specified problem condition for which the patient is undergoing and/or has undergone treatment, and (b) a treatment plan for the specified problem condition, wherein at least some of the care plan items correspond to treatment received from different healthcare providers, wherein the care plan depicts a medical history of the patient;
receiving, at the computer system, diagnosis information of the patient, the diagnosis information including a problem condition and a medical profile associated with the patient;
generating, by the computer system and using an evidence-based recommendation source, a care plan item including a recommended treatment plan for treating the problem condition associated with the patient;
adding, by the computer system, the care plan item to the care plan; and
storing, by the computer system, the care plan in the storage system.

2. The computer-implemented method of claim 1, wherein adding the care plan item includes:
receiving, at the computer system and from a specified healthcare provider of the healthcare providers the patient is interacting with, additional information for customizing the recommended treatment plan to generate a customized treatment plan, and
storing, by the computer system, the customized treatment plan as the care plan item in the storage system.

3. The computer-implemented method of claim 1, wherein generating the care plan item includes:
generating a goal of a treatment,
generating multiple instructions associated with the treatment, the instructions including at least one of a first instruction for the patient, a second instruction for a healthcare professional, or a third instruction for a specified healthcare provider of the healthcare providers with whom the patient is interacting, and
generating an orderable item for the treatment, the orderable item including information regarding any orders placed for the treatment.

4. The computer-implemented method of claim 1, wherein the care plan items include a specified care plan item that includes multiple treatment plans received from different healthcare providers for the same problem condition.

5. The computer-implemented method of claim 4, wherein the treatment plans of the specified care plan item is accessible by the different healthcare providers.

6. The computer-implemented method of claim 1 further comprising:
generating, by the computer system, a first care plan item of the multiple care plan items based on a first treatment plan received, at least in part, from a first healthcare provider of the healthcare providers, wherein the first treatment plan is provided for treating a first problem condition associated with the patient,
updating, by the computer system, the first care plan item based on a second treatment plan received, at least in part, from a second healthcare provider of the healthcare providers, and
storing, by the computer system, a revised version of the first care plan item in the storage system.

7. The computer-implemented method of claim 6, wherein updating the first care plan item includes:
updating at least one of a goal, instructions, an orderable, or a note associated with the first care plan item.

8. The computer-implemented method of claim 6 further comprising:
generating a notification for the second healthcare provider indicating that the first care plan item has been modified.

9. The computer-implemented method of claim 1, wherein generating the care plan item using the evidence-based recommendation source includes:
retrieving, from the evidence-based recommendation source, data representing multiple recommended treatment plans for multiple problem conditions for multiple types of patients, wherein the evidence-based recommendation source is provided by an entity different from the healthcare providers, and
storing, by the computer system, data representing the recommended treatment plans as a set of recommended care plan items in the storage system.

10. The computer-implemented method of claim 9 further comprising:
updating, by the computer system, the set of recommended care plan items in the storage system when the data representing the recommended treatment plans in the evidence-based recommendation source are updated by the entity.

11. The computer-implemented method of claim 9, wherein storing the date representing the recommended treatment plans as the set of recommended care plan items includes:
analyzing data representing each of the recommended treatment plans to identify at least one of a problem condition, a goal, an instruction, an orderable item, or a note of the corresponding recommended treatment plan,
extracting the at least one of the problem condition, the goal, the instruction, the orderable item, or the note of the corresponding recommended treatment plan, and
storing, in the storage system, the at least one of the problem condition, the goal, the instruction, the orderable item, or the note of the corresponding recommended treatment plan as one of the set of recommend care plan items.

12. The computer-implemented method of claim 1, wherein generating the care plan item using the evidence-based recommendation source includes:
retrieving, from the storage system, one of the set of recommended care plan items that matches with the problem condition and at least a part of the medical profile of the patient.

13. The computer-implemented method of claim 1, wherein each of the care plan items is associated with a status identifier, wherein the status identifier indicates at least one of (a) whether a problem condition corresponding to the care plan item is resolved, (b) whether the corresponding care plan item is active, suspended or discontinued, or (c) whether the patient is exempted from the corresponding care plan item.

14. The computer-implemented method of claim 1 further comprising:
automatically updating, by the computer system, a status indicator of a first care plan item, of the care plan items, from a first value to a second value based on an analysis of the first care plan item.

15. The computer-implemented method of claim 14, wherein updating the status indicator includes:
analyzing, by the computer system, the first care plan item to determine a treatment period associated with a treatment plan of the first care plan item,
confirming, by the computer system, the treatment period has expired, and
automatically updating, by the computer system, a status indicator of the first care plan item to a specified value indicating that a problem condition associated with the first care plan item is resolved.

16. The computer-implemented method of claim 15 further comprising:
sending a notification to the patient indicating that the problem condition associated with the first care plan item is resolved.

17. The computer-implemented method of claim 1 further comprising:
determining, by the computer system, a conflict between a first care plan item of the care plan items and a second care plan item of the care plan items, based on an analysis of the first care plan item and the second care plan item, and
sending a notification regarding the conflict to at least one of a first healthcare provider of the healthcare providers or a second healthcare provider of the healthcare providers, and to the patient.

18. The computer-implemented method of claim 17, wherein determining the conflict includes determining the conflict based on analysis of instructions of the first care plan item and the second care plan item.

19. The computer-implemented method of claim 17, wherein determining the conflict includes determining the conflict based on analysis of medication prescribed in the first care plan item and the second care plan item.

20. The computer-implemented method of claim 15 further comprising:
receiving, by the computer system, a request for a list of healthcare providers treating one or more problem conditions of the patient, and
retrieving, by the computer system, the list of healthcare providers from the care plan associated with the patient.

21. A computer-readable storage medium storing computer-readable instructions, comprising:
instructions for receiving, at a computer system, diagnosis information of a patient from a healthcare provider, the diagnosis information including a problem condition and multiple parameters associated with the patient;
instructions for retrieving, by the computer system and from a storage system, a specified care plan item of a care plan associated with the patient, wherein the care plan includes multiple care plan items in which each of the care plan items has (a) a particular problem condition for which the patient is undergoing and/or has undergone treatment, and (b) a treatment plan for the problem condition, wherein at least some of the care plan items correspond to treatment received from different healthcare providers, wherein the specified care plan item is associated with the problem condition;
instructions for updating, by the computer system, the specified care plan item based on the diagnosis information; and
instructions for storing, by the computer system, the care plan with an updated version of the specified care plan item in the storage system.

22. The computer-readable storage medium of claim 21, wherein the instructions for updating the specified care plan include:
instructions for updating at least one of a goal, an instruction, an orderable item, or a note of the specified care plan item based on the diagnosis information.

23. The computer-readable storage medium of claim 21, wherein the instructions for updating the specified care plan item include:
instructions for retrieving, from the care plan and for the specified care plan item, a medical history of treatment provided to the patient for the problem condition, the medical history facilitating the healthcare provider to diagnose the patient.

24. The computer-readable storage medium of claim 21 further comprising:
instructions for generating, by the computer system and using an evidence-based recommendation source, a first care plan item including recommended treatment plan for treating a first problem condition associated with the patient, and
instructions for storing, by the computer system, the first care plan item in the care plan.

25. The computer-readable storage medium of claim 24, wherein the instructions for generating the first care plan item using the evidence-based recommendation source include:
instructions for retrieving, from the evidence-based recommendation source, data representing multiple recommended treatment plans for multiple problem conditions for multiple types of patients, wherein the evidence-based recommendation source is provided by an entity different from any of the healthcare providers,
instructions for converting the data representing each of the multiple recommended treatment plans to a recommend care plan item which includes one or more of a goal of a treatment, instructions to the patient, an orderable item, or a note, and
instructions for storing, by the computer system, the recommended care plan items in the storage system.

26. A system, comprising:
a processor;
a first component configured to retrieve, from a storage system, a care plan associated with a patient, wherein the care plan includes multiple care plan items in which each of the care plan items has (a) a specified problem condition for which the patient is undergoing and/or has undergone treatment, and (b) a treatment plan for the specified problem condition, wherein at least some of the care plan items correspond to treatment received from different healthcare providers, wherein the care plan depicts a medical history of the patient, wherein the first component is further configured to receive diagnosis information of the patient including a problem condition and a medical profile of the patient; and
a second component configured to generate, using an evidence-based recommendation source, a care plan item having a recommended treatment plan for treating the problem condition associated with the patient, wherein the first component is further configured to:
add the care plan item to the care plan, and
store the care plan in the storage system.

27. The system of claim 26, wherein the second component is configured to generate the care plan item by:
generating, using the evidence-based recommendation source, a goal of a treatment,
generating, using the evidence-based recommendation source, multiple instructions associated with the treatment, the instructions including at least one of a first instruction for the patient, a second instruction for a healthcare professional, or a third instruction for a specified healthcare provider of the healthcare providers with whom the patient is interacting, and
generating, using the evidence-based recommendation source, an orderable item for the treatment, the orderable item including information regarding any orders placed for the treatment.
